(19) United States
(12) Patent Application Publication
(10) Pub. No.: US 2017/0169409 A1
(43) Pub. Date: Jun. 15, 2017

(54) METHOD AND ELECTRONIC DEVICE FOR INTUITIVELY PROMPTING PAYMENT AMOUNT

(71) Applicants: Le Holdings (Beijing) Co., Ltd., Beijing (CN); Lemobile Information Technology (Beijing) Co., Ltd., Beijing (CN)

(72) Inventor: Junwei LIU, Beijing (CN)

(21) Appl. No.: 15/250,849

(22) Filed: Aug. 29, 2016

Related U.S. Application Data
(63) Continuation of application No. PCT/CN2016/088913, filed on Jul. 6, 2016.

(30) Foreign Application Priority Data
Dec. 11, 2015 (CN) 201510921261.1

(51) Int. Cl. G06Q 20/14; G06Q 40/06

(52) U.S. Cl. CPC G06Q 20/14; G06Q 40/06

(57) ABSTRACT

A method and an electronic device for intuitively prompting a payment amount are disclosed. The method includes: at an electronic device, determining, when a payment amount is entered, the number of digits of the entered payment amount in real time; matching, according to a preset digit place loading rule, with a digit whose place needs to be loaded in the payment amount; and loading, to the corresponding digit in the payment amount, the place value that needs to be loaded, to intuitively indicate the place value of each digit in the payment amount. Embodiments of the present disclosure solve the disadvantages such as poor user experience caused by a lack of a place prompt for a payment amount in the related art, and in the embodiments of the present disclosure, it is unnecessary to check multiple times.

### CROSS REFERENCE TO RELATED APPLICATIONS

This present disclosure is a continuation of International Application No. PCT/CN2016/088913, filed on Jul. 6, 2016, which is based upon and claims priority to Chinese Patent Application No. 201510921261.1, filed on Dec. 11, 2015, the entire contents of which are incorporated herein by reference.

### TECHNICAL FIELD

The disclosure relates to the field of Internet technologies, and more particularly, to a method and an electronic device for intuitively prompting a payment amount.

### BACKGROUND

With rapid development of the Internet and the popularity of the “Internet Plus” concept, a mobile payment function is added to electronic devices on the market, which makes it convenient for users to make a transfer or payment at any time and in any place. During mobile payment, a payment amount generally needs to be entered in an amount input box; a user enters a number which is then directly displayed in the input box.

At present, the input box simply implements an input function, and is used to accept the number entered by the user; then the number is directly displayed in the input box, or after the number is entered, a thousands separator is added to the entered number. FIG. 13 is an interface for implementing a mobile payment function in the related art, wherein a number entered by a user is directly displayed in the input box without any separator. FIG. 14 is another interface for implementing a mobile payment function in the related art, wherein a difference from FIG. 13 is that separators are added.

However, during an implementation process of this application, the inventor finds that: by using transfer as an example, after a string of digits is entered, it is difficult to quickly recognize the order of magnitudes of the entered amount. Although thousands separators are added in some input boxes, for example, as illustrated in FIG. 14, users who are not sensitive to numbers or large amounts still have to determine the places in accordance with the ones place, tens place, thousands place, ten thousands place, and the like from the rear to the front. For example, during large-amount pay transfer, the amount “1114855” that needs to be transferred is entered, and to make sure whether the transfer amount is correct, the user needs to confirm the amount again or multiple times before clicking to confirm the transfer, so as to prevent any error in the transfer amount. This causes physiological distress to the user, and leads to relatively poor user experience.

### SUMMARY

This application is to provide a method and an electronic device for intuitively prompting a payment amount, to solve the disadvantages such as poor user experience caused by a lack of a place prompt for a payment amount in the related art.

The embodiments of this application use the following technical solutions:

An embodiment of this application provides a method for intuitively prompting a payment amount, including:

determining, when a payment amount is entered, the number of digits of the entered payment amount in real time;

matching, according to a preset digit place loading rule, with a digit whose place needs to be loaded in the payment amount; and

loading, to the corresponding digit in the payment amount, the place value that needs to be loaded, to intuitively indicate the place value of each digit in the payment amount.

An embodiment of the present disclosure further provides an electronic device, comprising: at least one processor; and a memory communicably connected with the at least one processor for storing instructions executable by the at least one processor, wherein execution of the instructions by the at least one processor causes the at least one processor to: determine, when a payment amount is entered, the number of digits of the entered payment amount in real time; match, according to a preset digit place loading rule, with a digit whose place needs to be loaded in the payment amount; and load, to the corresponding digit in the payment amount, the place value that needs to be loaded, to intuitively indicate the place value of each digit in the payment amount.

An embodiment of the present disclosure further provides a non-transitory computer-readable storage medium storing executable instructions that, when executed by an electronic device with a touch-sensitive display, cause the electronic device to: determining, when a payment amount is entered, the number of digits of the entered payment amount in real time; matching, according to a preset digit place loading rule, with a digit whose place needs to be loaded in the payment amount; and loading, to the corresponding digit in the payment amount, the place value that needs to be loaded, to intuitively indicate the place value of each digit in the payment amount.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for intuitively prompting a payment amount according to Embodiment 1 of the present disclosure;

FIG. 2 is a schematic flowchart illustrating a method for determining the number of digits of a payment amount according to Embodiment 2 of the present disclosure;

FIG. 3 is a schematic flowchart illustrating collecting statistics about a character string length according to Embodiment 3 of the present disclosure;

FIG. 4 is a schematic flowchart of matching with a digit whose place needs to be recorded according to Embodiment 4 of the present disclosure;

FIG. 5 is a schematic flowchart illustrating selecting, from digits corresponding to non-space characters, a digit whose place needs to be loaded according to Embodiment 5 of the present disclosure;

FIG. 6 is a schematic flowchart illustrating a method for intuitively prompting a payment amount according to Embodiment 6 of the present disclosure;

FIG. 7 is a schematic flowchart illustrating a method for intuitively prompting a payment amount according to Embodiment 7 of the present disclosure;

FIG. 8 is a schematic structural diagram illustrating an electronic device for intuitively prompting a payment amount according to Embodiment 8 of the present disclosure;

FIG. 9 is a schematic structural diagram illustrating an electronic device according to Embodiment 9 of the present disclosure;

FIG. 10 is a schematic structural diagram illustrating an electronic device according to Embodiment 10 of the present disclosure;

FIG. 11 is a first schematic diagram illustrating a payment interface to which any one of the foregoing embodiments of the present disclosure is applied;

FIG. 12 is a second schematic diagram illustrating a payment interface to which any one of the foregoing embodiments of the present disclosure is applied;

FIG. 13 illustrates an interface for implementing a mobile payment function in the related art;

FIG. 14 illustrates an interface for implementing another mobile payment function in the related art; and

FIG. 15 is a block diagram of an electronic device used to perform the method for intuitively prompting a payment amount according to an embodiment of the present disclosure.

### DETAILED DESCRIPTION

To make the objectives, technical solutions and advantages of the embodiments of the present disclosure clearer, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by persons of ordinary skill in the art without any creative efforts shall fall within the protection scope of the present disclosure.

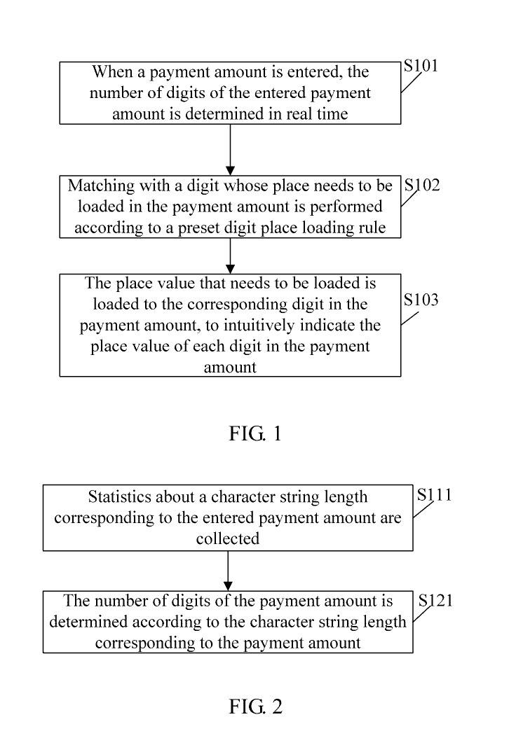

FIG. 1 is a schematic flowchart illustrating a method for intuitively prompting a payment amount according to Embodiment 1 of the present disclosure. As illustrated in FIG. 1, the method may at least include:

S101: When a payment amount is entered, the number of digits of the entered payment amount is determined in real time.

FIG. 2 is a schematic flowchart of a method for intuitively prompting a payment amount according to Embodiment 2 of the present disclosure; as illustrated in FIG. 2, the method may at least include:

S111: Statistics about a character string length corresponding to the entered payment amount are collected.

S121: The number of digits of the payment amount is determined according to the character string length corresponding to the payment amount.

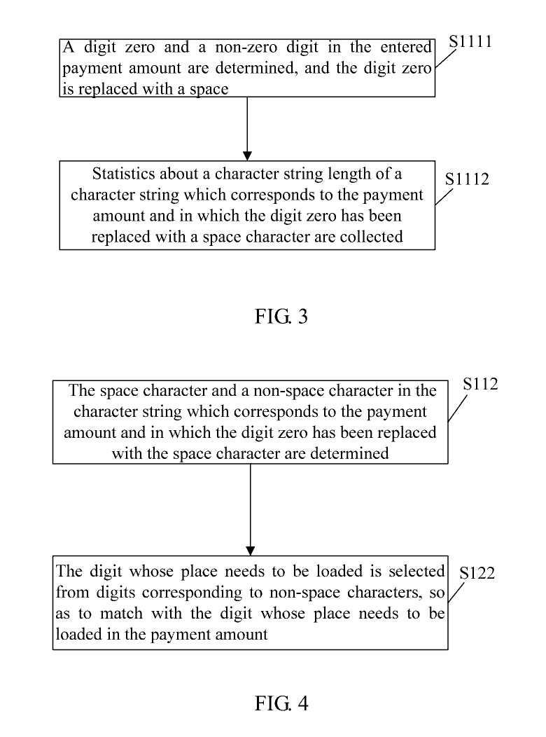

FIG. 3 is a schematic flowchart illustrating a method for collecting statistics about a character string length according to Embodiment 3 of the present disclosure; as illustrated in FIG. 3, the method may at least include:

S1111: A digit zero and a non-zero digit in the entered payment amount are determined, and the digit zero is replaced with a space.

S1112: Statistics about a character string length of a character string which corresponds to the payment amount and in which the digit zero has been replaced with a space character are collected.

The foregoing steps are described with reference to an example: the entered payment amount is “1010”, “0” is first replaced with a space to obtain “1 1”, and then a length of the character string “1 1” is acquired, wherein the length is 4, that is, the number of digits of the payment amount is 4; if prompting for the ones place is ignored, it can be directly learned that the places thereof are the thousands place, hundreds place, and tens place, and in subsequent steps, prompting of “thousand, hundred, ten” is performed selectively.

S102: Matching with a digit whose place needs to be loaded in the payment amount is performed according to a preset digit place loading rule.

Common places are “ones place, tens place, hundreds place, thousands place, ten thousands place . . . ”; the digit loading rule specifies whether place prompting is performed for all digits or place prompting is performed for only the top digit; and correspondingly, whether matching with all digits of payment amount digits or matching with the top digit of payment amount digits is performed.

FIG. 4 is a schematic flowchart of matching with a digit whose place needs to be recorded according to Embodiment 4 of the present disclosure; as illustrated in FIG. 4, this embodiment is executed based on the content of FIG. 3, and this embodiment may at least include:

S112: The space character and a non-space character in the character string which corresponds to the payment amount and in which the digit zero has been replaced with the space character are determined.

S122: The digit whose place needs to be loaded is selected from digits corresponding to non-space characters, so as to match with the digit whose place needs to be loaded in the payment amount.

FIG. 5 is a schematic flowchart illustrating selecting, from digits corresponding to non-space characters, a digit whose place needs to be loaded according to Embodiment 5 of the present disclosure. As illustrated in FIG. 5, this embodiment may at least include:

S1221: The character string which corresponds to the payment amount and in which the digit zero has been replaced with the space is traversed.

S1222: Digits corresponding to non-space characters are determined, and the digit whose place needs to be loaded is selected from the digits corresponding to the non-space characters.

Based on the foregoing example, the characters of “1 1” are further traversed one by one from the left to the right for example, or may be traversed from the right to the left, wherein 1 at the thousands place and 1 at the tens place are digits corresponding to the space; if place prompting needs to be performed on the two digits, 1 at the thousands place and 1 at the tens place are digits whose places need to be loaded, and in subsequent Step S103, place prompting is performed on the two digits, that is, “thousand ten”.

S103: The place value that needs to be loaded is loaded to the corresponding digit in the payment amount, to intuitively indicate the place value of each digit in the payment amount.

Specifically, in an embodiment of the present disclosure, the loading, to the corresponding digit in the payment amount, the place value that needs to be loaded, to intuitively indicate the place value of each digit in the payment amount includes: loading, to the corresponding digit in the payment amount, the place value that needs to be loaded, and displaying, on a payment page, the place value that needs to be loaded.

In specific implementation, the corresponding place may be directly displayed above the corresponding digit, or the payment amount is directly converted into a voice prompt.

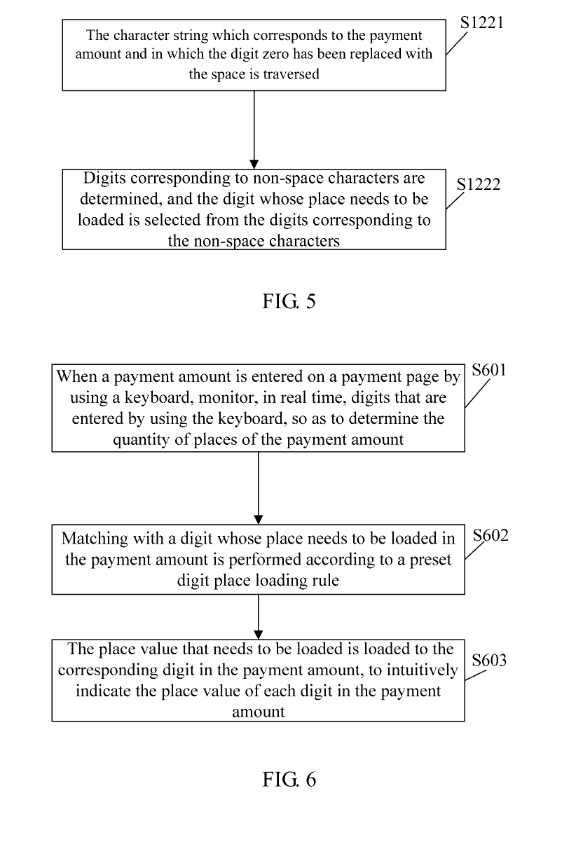

FIG. 6 is a schematic flowchart illustrating a method for intuitively prompting a payment amount according to Embodiment 6 of the present disclosure. As illustrated in FIG. 3, the method may at least include:

S601: When a payment amount is entered on a payment page by using a keyboard, digits that are entered by using the keyboard are monitored in real time, so as to determine the number of digits of the payment amount.

In this embodiment, when a user enters digits, digits selected for operation on the keyboard may also be monitored, so as to determine the number of digits of the entered payment amount, wherein the keyboard may use common mechanical keys or touch keys.

For the mechanical keys, each key corresponds to a key value, and an operated digit is determined according to a corresponding relationship between key values and keys.

For the touch keys, different input methods may correspond to different input operation interfaces, and an operated digit may be determined according to a corresponding relationship between key values and keys in a specific input method.

S602: Matching with a digit whose place needs to be loaded in the payment amount is performed according to a preset digit place loading rule.

S603: The place value that needs to be loaded is loaded to the corresponding digit in the payment amount, to intuitively indicate the place value of each digit in the payment amount.

Steps S602 to S603 are not described repeatedly herein, and for details, reference may be made to the description in FIG. 1 to FIG. 6 above.

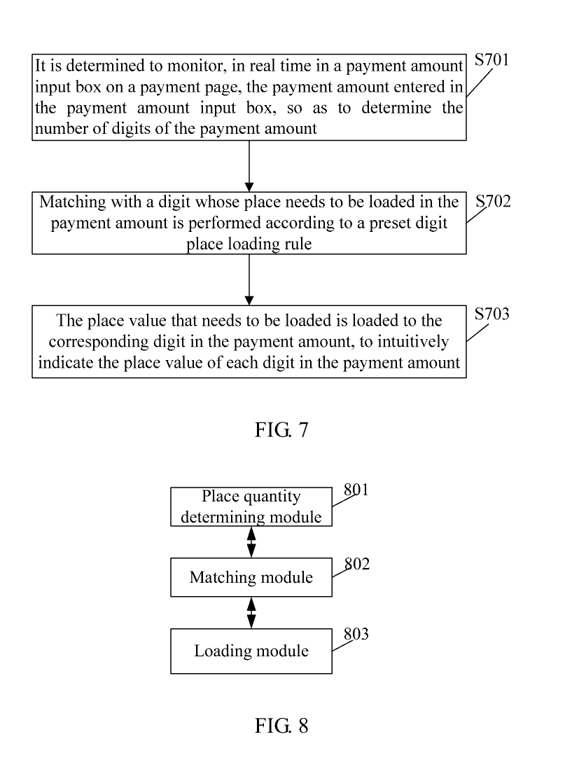

FIG. 7 is a schematic flowchart illustrating a method for intuitively prompting a payment amount according to Embodiment 7 of the present disclosure. As illustrated in FIG. 7, the method may at least include:

S701: It is determined to monitor, in real time in a payment amount input box on a payment page, the payment amount entered in the payment amount input box, so as to determine the number of digits of the payment amount.

In a case of a third-party payment application program, digits entered in the amount input box on the payment page are directly monitored, so as to determine the number of digits of the payment amount. Specifically, a monitor (Text Watcher) may be added to Edit Text of the input box, and each time a user enters one digit, a text change method (on Text Changed) is triggered, and the number of digits of the payment amount is determined in the text change method (on Text Changed).

After a text change is monitored, digital content entered in the input box is acquired by means of a method (get Text).

S702: Matching with a digit whose place needs to be loaded in the payment amount is performed according to a preset digit place loading rule.

S703: The place value that needs to be loaded is loaded to the corresponding digit in the payment amount, to intuitively indicate the place value of each digit in the payment amount.

A popup text prompt box (Popup Window) is provided according to the digital content, wherein a text box (Text View) is displayed in the prompt box, and the font size of the text box may be the same as that of the input box; the place that needs to be indicated is loaded into the text box, to intuitively display the corresponding place of the corresponding digit.

FIG. 8 is a schematic structural diagram of an electronic device for intuitively prompting a payment amount according to Embodiment 8 of the present disclosure; as illustrated in FIG. 8, the electronic device may include: a place quantity determining module 801, a matching module 802, and a loading module 803.

The place quantity determining module 801 is configured to determine, when a payment amount is entered, the number of digits of the entered payment amount.

The matching module 802 is configured to match, according to a preset digit place loading rule, with a digit whose place needs to be loaded in the payment amount.

The loading module 803 is configured to load, to the corresponding digit in the payment amount, the place value that needs to be loaded, to intuitively indicate the place value of each digit in the payment amount.

Optionally, the place quantity determining module 801 may be further configured to monitor, in real time when the payment amount is entered on a payment page by using a keyboard, digits that are entered by using the keyboard, so as to determine the number of digits of the payment amount.

Optionally, the place quantity determining module 801 may be further configured to determine to monitor, in real time in a payment amount input box on a payment page, the payment amount entered in the payment amount input box, so as to determine the number of digits of the payment amount.

Optionally, the matching module 802 may be further configured to match, according to preset place prompting logic, the digit whose place needs to be loaded in the payment amount, wherein the digit loading rule includes the place prompting logic.

Optionally, the place quantity determining module 801 may be further configured to collect statistics about a character string length corresponding to the payment amount; and determine the number of digits of the payment amount according to the character string length corresponding to the payment amount.

Specifically, when collecting statistics about the character string, the place quantity determining module 801 may be specifically configured to determine a digit zero and a non-zero digit in the entered payment amount, and replace the digit zero with a space; and collect statistics about a character string length of a character string which corresponds to the payment amount and in which the digit zero has been replaced with a space character.

Specifically, the matching module 802 may be further configured to determine the space character and a non-space character in the character string which corresponds to the payment amount and in which the digit zero has been replaced with the space character; and select, from digits corresponding to non-space characters, the digit whose place needs to be loaded, so as to match with the digit whose place needs to be loaded in the payment amount.

Specifically, the matching module 802 may further traverse the character string which corresponds to the payment amount and in which the digit zero has been replaced with the space; and determine digits corresponding to non-space characters, and select, from the digits corresponding to the non-space characters, the digit whose place needs to be loaded.

Optionally, the loading module 803 may be further configured to load, to the corresponding digit in the payment amount, the place value that needs to be loaded, and display, on a payment page, the place value that needs to be loaded.

It should be noted that, the function specifically implemented by any one of the foregoing functional modules may be implemented by modules that are functionally cooperative with each other, and details are not described herein again.

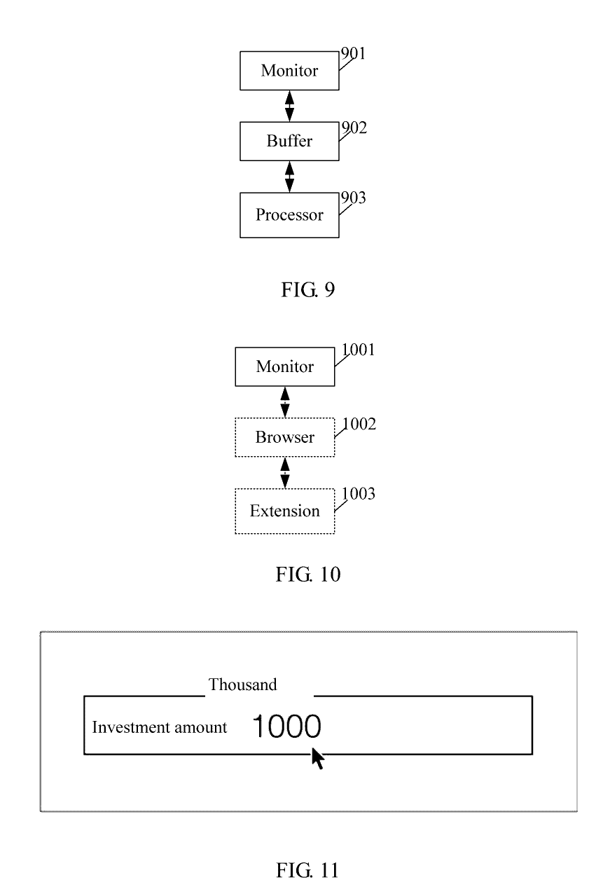

FIG. 9 is a schematic structural diagram illustrating an electronic device according to Embodiment 9 of the present disclosure; as illustrated in FIG. 9, the electronic device may include: a monitor 901, a buffer 902, and a processor 903, and when a third-party payment application program installed on the electronic device is started to use an operation such as transfer or payment.

The processor 903 is configured to determine, when a payment amount is entered on an operation page of the third-party payment application program, the number of digits of the entered payment amount in real time.

The processor 903 is configured to match, according to a preset digit place loading rule, with a digit whose place needs to be loaded in the payment amount.

The processor 903 is further configured to load, to the corresponding digit in the payment amount, the place value that needs to be loaded, to intuitively indicate, on the monitor 901, the place value of each digit in the payment amount.

The buffer 902 is configured to buffer any of the foregoing data during a working process of the processor 903.

Optionally, the processor 903 may be further configured to monitor, in real time when the payment amount is entered on a payment page by using a keyboard, digits that are entered by using the keyboard, so as to determine the number of digits of the payment amount.

Optionally, the processor 903 may be further configured to determine to monitor, in real time in a payment amount input box on a payment page, the payment amount entered in the payment amount input box, so as to determine the number of digits of the payment amount.

Optionally, the processor 903 may be further configured to match, according to preset place prompting logic, the digit whose place needs to be loaded in the payment amount, wherein the digit loading rule includes the place prompting logic.

Optionally, the processor 903 may be further configured to collect statistics about a character string length corresponding to the payment amount; and determine the number of digits of the payment amount according to the character string length corresponding to the payment amount.

Specifically, when collecting statistics about the character string, the processor 903 may be specifically configured to determine a digit zero and a non-zero digit in the entered payment amount, and replace the digit zero with a space; and collect statistics about a character string length of a character string which corresponds to the payment amount and in which the digit zero has been replaced with a space character.

Specifically, the processor 903 may be further configured to determine the space character and a non-space character in the character string which corresponds to the payment amount and in which the digit zero has been replaced with the space character; and select, from digits corresponding to non-space characters, the digit whose place needs to be loaded, so as to match with the digit whose place needs to be loaded in the payment amount.

Specifically, the processor 903 may further traverse the character string which corresponds to the payment amount and in which the digit zero has been replaced with the space; and determine digits corresponding to non-space characters, and select, from the digits corresponding to the non-space characters, the digit whose place needs to be loaded.

Optionally, the processor 903 may be further configured to load, to the corresponding digit in the payment amount, the place value that needs to be loaded, and display, on a payment page, the place value that needs to be loaded.

It should be noted that, the function specifically implemented by any one of the foregoing functional modules may be implemented by modules that are functionally cooperative with each other, and details are not described herein again.

The technical solution as illustrated FIG. 9 may be applied to a device, such as a smart phone or a tablet computer, on which a third-party mobile payment application program can be installed.

FIG. 10 is a schematic structural diagram of an electronic device according to Embodiment 10 of the present disclosure; as illustrated in FIG. 10, the electronic device may include: a monitor 1001 and a browser 1002, wherein an extension 1003 is installed in the browser 1002 of the electronic device, and when an operation such as payment page transfer or payment is used on the webpage browser 1002 of the electronic device.

The extension 1003 is configured to determine, when a payment amount is entered on an operation page of the third-party payment application program, the number of digits of the entered payment amount in real time.

The extension 1003 is configured to match, according to a preset digit place loading rule, with a digit whose place needs to be loaded in the payment amount.

The extension 1003 is further configured to load, to the corresponding digit in the payment amount, the place value that needs to be loaded, to intuitively indicate, on the monitor 1001, the place value of each digit in the payment amount.

Optionally, the extension 1003 may be further configured to monitor, in real time when the payment amount is entered on a payment page by using a keyboard, digits that are entered by using the keyboard, so as to determine the number of digits of the payment amount.

Optionally, the extension 1003 may be further configured to determine to monitor, in real time in a payment amount input box on a payment page, the payment amount entered in the payment amount input box, so as to determine the number of digits of the payment amount.

Optionally, the extension 1003 may be further configured to match, according to preset place prompting logic, the digit whose place needs to be loaded in the payment amount, wherein the digit loading rule includes the place prompting logic.

Optionally, the extension 1003 may be further configured to collect statistics about a character string length corresponding to the payment amount; and determine the number of digits of the payment amount according to the character string length corresponding to the payment amount.

Specifically, when collecting statistics about the character string, the extension 1003 may be specifically configured to determine a digit zero and a non-zero digit in the entered payment amount, and replace the digit zero with a space; and collect statistics about a character string length of a character string which corresponds to the payment amount and in which the digit zero has been replaced with a space character.

Specifically, the extension 1003 may be further configured to determine the space character and a non-space character in the character string which corresponds to the payment amount and in which the digit zero has been replaced with the space character; and select, from digits corresponding to non-space characters, the digit whose place needs to be loaded, so as to match with the digit whose place needs to be loaded in the payment amount.

Specifically, the extension 1003 may further traverse the character string which corresponds to the payment amount and in which the digit zero has been replaced with the space; and determine digits corresponding to non-space characters, and select, from the digits corresponding to the non-space characters, the digit whose place needs to be loaded.

Optionally, the extension 1003 may be further configured to load, to the corresponding digit in the payment amount, the place value that needs to be loaded, and display, on a payment page, the place value that needs to be loaded.

For a functional structure of the extension 1003, reference may be made to FIG. 8, and details are not described herein again.

The technical solution of the embodiment in FIG. 10 above may be applied to terminals such as a PC terminal on which the browser 1002 can be installed, for example, transfer, remittance, and the like are implemented by using a bank interface, a third-party payment page (Alipay) or the like on the browser 1002, and details are not described herein.

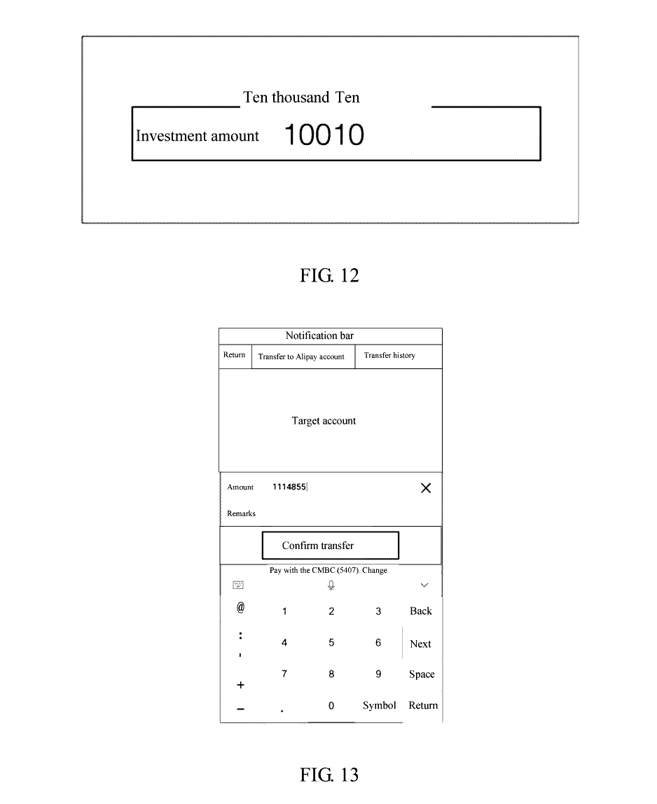

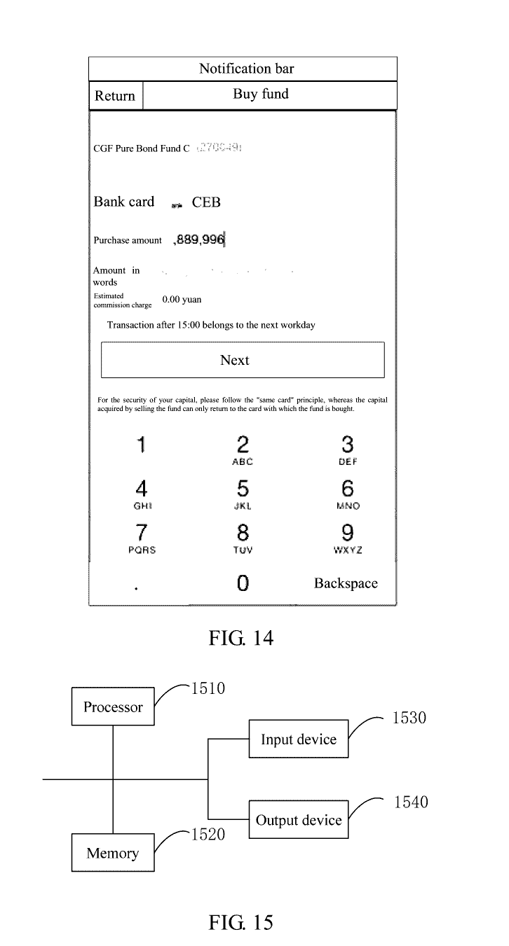

FIG. 11 is a first schematic diagram illustrating a payment interface to which any one of the foregoing embodiments of the present disclosure is applied. As illustrated in FIG. 11, “thousand” is displayed above the thousands place “1” of 1000, and in this way, it can be quickly learned that the entered amount is “1000”. FIG. 12 is a second schematic diagram of a payment interface to which any one of the foregoing embodiments of the present disclosure is applied, wherein “ten thousand” is displayed above the ten thousands place “1” of 10010, and “1” is displayed above the tens place; in this way, it can be quickly learned that the entered amount is “10010”.

Another embodiment of the present disclosure further provides a non-transitory computer-readable storage medium storing executable instructions that, when executed by an electronic device with a touch-sensitive display, cause the electronic device to: determining, when a payment amount is entered, the number of digits of the entered payment amount in real time; matching, according to a preset digit place loading rule, with a digit whose place needs to be loaded in the payment amount; and loading, to the corresponding digit in the payment amount, the place value that needs to be loaded, to intuitively indicate the place value of each digit in the payment amount

In the foregoing embodiment, separators may also be added. Conventionally, separators are disposed at intervals of three digits, and therefore, the existence of a separator facilitates determining places rapidly.

The electronic device embodiment described above is merely exemplary. The modules described as separate parts may or may not be physically separate, and the parts displayed as modules may or may not be physical modules, that is, they may be located at one position or may be distributed on a plurality of network modules. Some or all of the modules may be selected according to actual needs to achieve the objective of the solution of this embodiment. Persons of ordinary skill in the art may understand and implement the embodiment without creative efforts.

FIG. 15 is a block diagram of an electronic device used to perform the method for intuitively prompting a payment amount according to an embodiment of the present disclosure, as shown in FIG. 15, the device includes:

One or more processors 1510 and a memory 1520, FIG. 15 illustrates one processor 1510 as an example.

The device for the method for intuitively prompting a payment amount may further include an input device 1530 and an output device 1540.

The processor 1510, the memory 1520, the input device 1530 and the output device 1540 may be connected with each other through bus or other forms of connections. FIG. 15 illustrates bus connection as an example.

As a non-volatile computer-readable storage medium, the memory 1520 may be configured to store non-volatile software program, non-volatile computer executable program and modules, such as program instructions/modules corresponding to the method for intuitively prompting a payment amount according to the embodiments of the disclosure. By executing the non-volatile software program, instructions and modules stored in the memory 1520, the processor 1510 may perform various functional disclosures of the server and data processing, that is, the method for intuitively prompting a payment amount according to the above mentioned embodiments.

The memory 1520 may include a program storage area and a data storage area, wherein, the program storage area may be stored with the operating system and disclosures which are needed by at least one functions, and the data storage area may be stored with data which is created according to use of the device for intuitively prompting a payment amount. Further, the memory 1520 may include a high-speed random access memory, and may further include non-volatile memory, such as at least one of disk memory device, flash memory device or other types of non-volatile solid state memory device. In some embodiments, optionally, the memory 1520 may include memory provided remotely from the processor 1510, and such remote memory may be connected with the device for intuitively prompting a payment amount through network connections, the examples of the network connections may include but not limited to internet, intranet, LAN (Local Area Network), mobile communication network or combinations thereof.

The input device 1530 may receive inputted number or character information, and generate key signal input related to the user settings and functional control of the device for intuitively prompting a payment amount. The output device 1540 may include a display device such as a display screen.

The above one or more modules may be stored in the memory 1520, when these modules are executed by the one or more processors 1510, the method for intuitively prompting a payment amount according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone®), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad®;

(3) portable entertainment device, which can display and play multimedia contents, and includes audio or video player (such as iPod®), portable game console, E-book and smart toys and portable vehicle navigation device;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A method for intuitively prompting a payment amount at an electronic device, comprising:
determining, when a payment amount is entered, the number of digits of the entered payment amount in real time;
matching, according to a preset digit place loading rule, with a digit whose place needs to be loaded in the payment amount; and
loading, to the corresponding digit in the payment amount, the place value that needs to be loaded, to intuitively indicate the place value of each digit in the payment amount.

2. The method according to claim 1, wherein the monitoring, when a payment amount is entered, the number of digits of the entered payment amount in real time, comprises:
when the payment amount is entered on a payment page by using a keyboard, monitoring, in real time, digits that are entered by using the keyboard, so as to determine the number of digits of the payment amount.

3. The method according to claim 1, wherein the monitoring, when a payment amount is entered, the number of digits of the entered payment amount in real time comprises:
determining to monitor, in real time in a payment amount input box on a payment page, the payment amount entered in the payment amount input box, so as to determine the number of digits of the payment amount.

4. The method according to claim 1, wherein the matching, according to a preset digit place loading rule, with a digit whose place needs to be loaded in the payment amount comprises: matching, according to preset place prompting logic, the digit whose place needs to be loaded in the payment amount, wherein the digit loading rule comprises the place prompting logic.

5. The method according to claim 1, wherein the determining, when a payment amount is entered, the number of digits of the entered payment amount in real time comprises:
collecting statistics about a character string length corresponding to the entered payment amount; and
determining the number of digits of the payment amount according to the character string length corresponding to the payment amount.

6. The method according to claim 5, wherein the collecting statistics about a character string length corresponding to the entered payment amount comprises:
determining a digit zero and a non-zero digit in the entered payment amount, and replacing the digit zero with a space; and
collecting statistics about a character string length of a character string which corresponds to the payment amount and in which the digit zero has been replaced with a space character.

7. The method according to claim 6, wherein the matching, according to a preset digit place loading rule, with a digit whose place needs to be loaded in the payment amount comprises:
determining the space character and a non-space character in the character string which corresponds to the payment amount and in which the digit zero has been replaced with the space character; and
selecting, from digits corresponding to non-space characters, the digit whose place needs to be loaded, so as to match with the digit whose place needs to be loaded in the payment amount.

8. The method according to claim 7, wherein the selecting, from digits corresponding to non-space characters, the digit whose place needs to be loaded, so as to match with the digit whose place needs to be loaded in the payment amount comprises:
traversing the character string which corresponds to the payment amount and in which the digit zero has been replaced with the space; and
determining digits corresponding to non-space characters, and selecting, from the digits corresponding to the non-space characters, the digit whose place needs to be loaded.

9. The method according to claim 1, wherein the loading, to the corresponding digit in the payment amount, the place value that needs to be loaded, to intuitively indicate the place value of each digit in the payment amount comprises: loading, to the corresponding digit in the payment amount, the place value that needs to be loaded, and displaying, on a payment page, the place value that needs to be loaded.

10. An electronic device, comprising:
at least one processor; and
a memory communicably connected with the at least one processor for storing instructions executable by the at least one processor, wherein execution of the instructions by the at least one processor causes the at least one processor to:
determine, when a payment amount is entered, the number of digits of the entered payment amount in real time;
match, according to a preset digit place loading rule, with a digit whose place needs to be loaded in the payment amount; and
load, to the corresponding digit in the payment amount, the place value that needs to be loaded, to intuitively indicate the place value of each digit in the payment amount.

11. The electronic device according to claim 10, wherein the monitoring, when a payment amount is entered, the number of digits of the entered payment amount in real time cause the at least one processor to:
when the payment amount is entered on a payment page by using a keyboard, monitor, in real time, digits that are entered by using the keyboard, so as to determine the number of digits of the payment amount.

12. The electronic device according to claim 10, wherein the monitoring, when a payment amount is entered, the number of digits of the entered payment amount in real time cause the at least one processor to:
determine to monitor, in real time in a payment amount input box on a payment page, the payment amount entered in the payment amount input box, so as to determine the number of digits of the payment amount.

13. The electronic device according to claim 10, wherein the matching, according to a preset digit place loading rule, with a digit whose place needs to be loaded in the payment amount cause the at least one processor to: match, according to preset place prompting logic, the digit whose place needs to be loaded in the payment amount, wherein the digit loading rule comprises the place prompting logic.

14. The electronic device according to claim 10, wherein the determining, when a payment amount is entered, the number of digits of the entered payment amount in real time cause the at least one processor to:
collect statistics about a character string length corresponding to the entered payment amount; and
determine the number of digits of the payment amount according to the character string length corresponding to the payment amount.

15. A non-transitory computer-readable storage medium storing executable instructions that, when executed by an electronic device cause the electronic device to:
determine, when a payment amount is entered, the number of digits of the entered payment amount in real time;
match, according to a preset digit place loading rule, with a digit whose place needs to be loaded in the payment amount; and
load, to the corresponding digit in the payment amount, the place value that needs to be loaded, to intuitively indicate the place value of each digit in the payment amount.

16. The non-transitory computer-readable storage medium according to claim 15, wherein the monitoring, when a payment amount is entered, the number of digits of the entered payment amount in real time, comprises:
when the payment amount is entered on a payment page by using a keyboard, monitoring, in real time, digits that are entered by using the keyboard, so as to determine the number of digits of the payment amount.

17. The non-transitory computer-readable storage medium according to claim 15, wherein the monitoring, when a payment amount is entered, the number of digits of the entered payment amount in real time comprises:
determining to monitor, in real time in a payment amount input box on a payment page, the payment amount entered in the payment amount input box, so as to determine the number of digits of the payment amount.

18. The non-transitory computer-readable storage medium according to claim 15, wherein the matching, according to a preset digit place loading rule, with a digit whose place needs to be loaded in the payment amount comprises: matching, according to preset place prompting logic, the digit whose place needs to be loaded in the payment amount, wherein the digit loading rule comprises the place prompting logic.

19. The non-transitory computer-readable storage medium according to claim 15, wherein the determining, when a payment amount is entered, the number of digits of the entered payment amount in real time comprises:
collecting statistics about a character string length corresponding to the entered payment amount; and
determining the number of digits of the payment amount according to the character string length corresponding to the payment amount.
